(19) United States
(12) Patent Application Publication
(10) Pub. No.: US 2001/0029496 A1
(43) Pub. Date: Oct. 11, 2001

(54) Systems and methods for providing anonymous financial transactions

(76) Inventors: Ray Karl Otto, san Franisco, CA (US); Martin P. Murrell, Washington, DC (US); Stephen Mugford, Wellesley, MA (US); Michael J. Rowen, Oakton, VA (US); Steven W. Pearlman, Washington, DC (US)

Correspondence Address: Finnegan, Henderson, Farabow,, Garrett & Dunner, L.L.P., 1300 I Street, N.W., Washington, DC, 20005-3315, US

(21) Appl. No.: 09/790,488

(22) Filed: Feb. 23, 2001

Related U.S. Application Data
(60) Provisional application No. 60/184,320, filed on Feb. 23, 2000.

(51) Int. Cl. G06F 17/60

(52) U.S. Cl. 705/74

(57) ABSTRACT

The present invention relates generally to methods and apparatus for providing anonymous financial transactions. A user can apply for an anonymous financial account through a financial organization. The user is approved, an anonymous account is established and the user is notified. Once the anonymous account and associated card (if needed) is activated, the user can make anonymous purchases and have goods delivered anonymously, wherein the merchant does not know the user's real identity or address.

### RELATED APPLICATION DATA

This application is related to and claims priority to U.S. Provisional Application No. 60/184,320, filed Feb. 23, 2000, entitled “Systems and Methods for Providing Anonymous Electronic Commerce” which is expressly incorporated herein by reference in its entirety.

### BACKGROUND OF THE INVENTION

1. Field of the Invention

The present invention relates generally to electronic commerce, and, more specifically, to systems and methods for providing anonymous financial transactions.

2. Description of Related Art

With the popularity of the Internet increasing, both from the consumer's and merchant's perspective, many consumers have changed the focus of their spending habits from the traditional department or bricks-and-mortar store to the on-line merchant. This is due to the number of advantages the Internet provides for performing transactions. For example, a consumer only needs to turn on their computer, access a merchant on-line, select a product for purchasing, provide for payment, and receive that product in the mail-all without leaving the confines of their own home.

However, as the popularity of the Internet has increased, it has also become a productive and lucrative way to collect information on consumers' shopping and spending habits. Merchants can track a consumer's access to their web site and store information on what products a consumer views at their web site. They can also store information as to what products are purchased. In some instances, the merchant can also access the web site history on the consumer's computer to see what sites the consumer has visited. The merchants can then either use this information for their own purposes, or can sell this information to others. But many users would rather keep this information private.

Currently, there are proxy servers located on the Internet which may provide for anonymous Internet access. In particular, the proxy server prevents on-line merchants and other entities on the Internet from determining the identity of the user. However, even with proxy servers, once a consumer has decided to make an on-line purchase, their anonymity is gone once their payment information or their shipping information is given to the merchant. Thus, there remains a need for a system allowing users to anonymously purchase goods and services over a network.

### SUMMARY OF THE INVENTION

In accordance with the principles of the invention, as embodied and broadly described herein, methods and systems consistent with the principles of the invention provide for an anonymous financial account, including: receiving financial account application information from an applicant for the anonymous financial account; processing the financial account application information for the applicant to determine if the anonymous financial account should be opened for the applicant; determining that the financial account application has been accepted; and establishing the anonymous financial account for the applicant.

Further principles consistent with the invention provide for methods and systems for providing for anonymous financial transactions, including: receiving a request to process an anonymous financial transaction containing anonymous information; accessing an anonymous account using the anonymous information for processing; determining that the anonymous transaction should be approved; and responding to the request that the anonymous transaction is approved.

Further principles consistent with the invention provide for methods and systems for making an anonymous financial transaction including applying for an anonymous financial account; opening an anonymous financial account with an anonymous financial account provider; making an anonymous purchase on the anonymous financial account; and receiving the goods of the anonymous purchase.

Further principles consistent with the invention provide for methods and systems for shipping goods purchased from a merchant using an anonymous financial account so that the goods are received by a consumer associated with the anonymous financial account, the consumer having an anonymous shipping address, including: labeling the goods with the anonymous shipping address; identifying an actual address of the consumer based on the anonymous shipping address; and re-directing the goods to the actual address of the consumer.

Further principles consistent with the invention provide for methods and systems for conducting an anonymous financial transaction including: accessing a site on a network anonymously; purchasing goods from the site using an anonymous financial account; and receiving the goods from the purchase.

Further principles consistent with the invention provide for methods and systems for providing for anonymous financial transactions including: receiving a request to register a financial account from an issuing financial provider as an anonymous financial account; establishing an anonymous financial account associated with the financial account in response to the request; receiving a request to purchase goods from a merchant using the anonymous financial account; processing the request from the merchant; and responding to the merchant's request including a response.

Additional features and aspects of the invention will be set forth in part in the description which follows, and in part will be obvious from the description, or may be learned by practice of the invention. The features and aspects of the invention will be realized and attained by means of the elements and combinations particularly pointed out in the appended claims.

### BRIEF DESCRIPTION OF THE DRAWINGS

The accompanying drawings, which are incorporated in and constitute a part of this specification, illustrate embodiments of the invention and, together with the description, explain the principles of the invention. In the drawings:

FIG. 1 is an exemplary system environment for implementing the features of the present invention;

FIG. 2 is an exemplary diagram of the components of a client computer, consistent with the present invention;

FIG. 3 depicts an exemplary flow diagram of the steps performed by a user to establish an anonymous account, consistent with the present invention;

FIG. 4 depicts an exemplary flow diagram of the steps performed by a financial institution for establishing an anonymous financial account for a user, consistent with the present invention;

FIG. 5 depicts an exemplary flow diagram of the steps performed by a user for conducting an anonymous purchase on a network, consistent with the present invention;

FIG. 6 depicts an exemplary flow diagram of the steps performed by a proxy server to provide anonymous access to a network, consistent with the present invention;

FIG. depicts an exemplary flow diagram of the steps performed by a proxy server in assisting a user in conducting an anonymous financial transaction, consistent with the present invention;

FIG. 8 depicts an exemplary flow diagram of the steps for processing an anonymous purchase, consistent with the present invention;

FIG. 9 depicts an exemplary flow diagram of the steps for shipping goods purchased anonymously, consistent with the present invention; and

FIG. 10 depicts an exemplary flow diagram of the steps performed by a financial institution for processing an authorization request, consistent with the present invention.

### DETAILED DESCRIPTION

Reference will now be made in detail to the features of the principles of the present invention, examples of which are illustrated in the accompanying drawings. Wherever possible, the same reference numbers will be used throughout the drawings to refer to the same or like parts.

The present invention relates generally to methods and systems for providing anonymous electronic commerce transactions. In systems consistent with the present invention, a user can apply for an anonymous financial account through a financial organization, such as a major credit card issuer or bank. The anonymous financial account may be implemented as any type of financial account such as a debit card account, credit card account, charge card account, bank card account, or pre-paid or stored value account. If the user is approved for the anonymous financial account, an account is established for permitting anonymous financial transactions. There are at least two identities that are associated with the anonymous financial account, the first corresponding to the user's real or non-anonymous identity and the second corresponding to an anonymous identity that is created for the user. The user's anonymous account can be accessed by using either identity.

The anonymous account is created like a typical financial account, but has anonymous identifying information associated with it. This anonymous identifying information can include an anonymous name, anonymous account number, anonymous address, and/or anonymous expiration date. The anonymous identifying information may also include other appropriate anonymous features such as check digits and security measures such as card verification value 2 (“CVV2”) encrypted numbers. Merchants, merchant banks and association networks process the transactions just as typical financial transactions are processed, however the anonymous identifying information is processed, instead of the real identifying information.

When a user accesses a merchant's web site to make a purchase, the user can submit the anonymous identifying information to the merchant. The merchant then submits the transaction request to the interchange or banking network, who then forwards the request to the financial institution that issued the anonymous card. The financial institution can associate the anonymous identifying information with the user's real identifying information, and decide whether or not to authorize the transaction. This decision is forwarded back to the interchange or banking network, maintaining the anonymous identifying information, which is finally forwarded to the merchant. A merchant, therefore, is never provided with information pertaining to the user's real identity. Accordingly, the user can purchase goods or services using the anonymous identity such that a merchant never knows of the user's real identity.

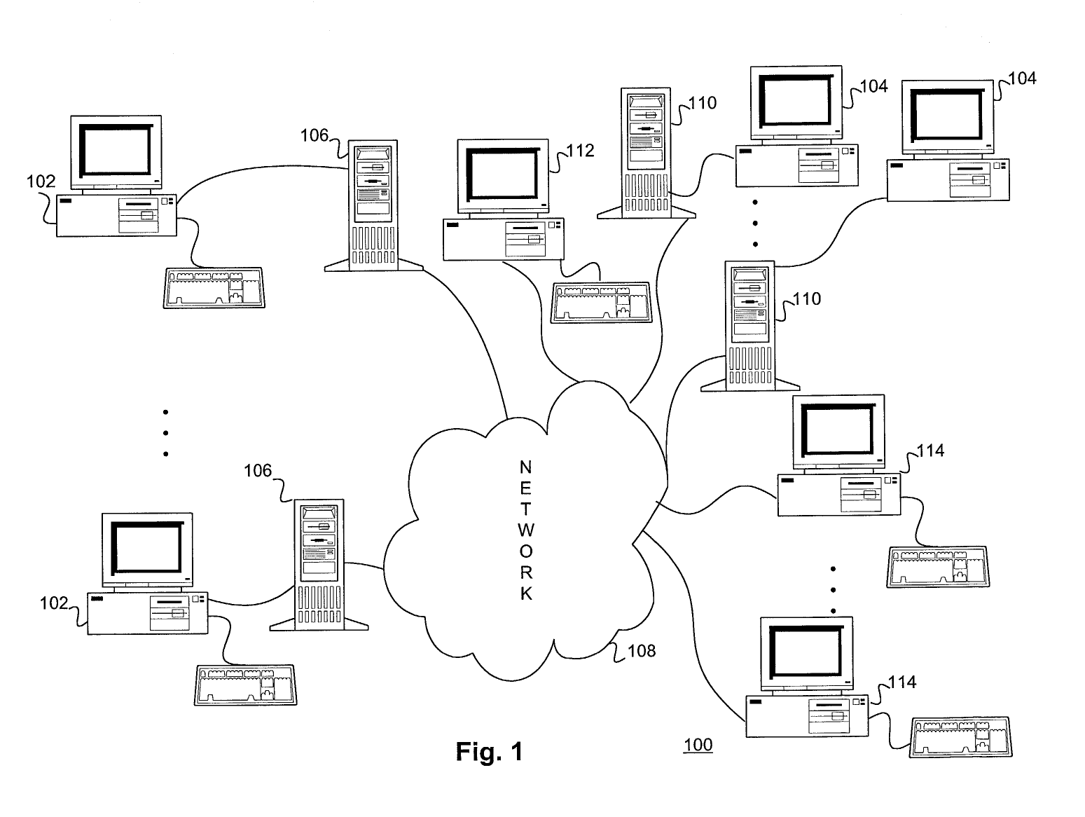

FIG. 1 is an exemplary diagram of a system environment 100 for implementing the principles of the present invention. The components of system 100 can be implemented through any suitable combinations of hardware, software and/or firmware. As shown in FIG. 1, system 100 includes a plurality of client computers 102 and 104, Internet Service Providers (ISP) 106, proxy servers 110, a financial institution server 112 and a plurality of merchant servers 114, each communicating with one another via network 108. While network 108 is preferably the Internet, network 108 may be any local or wide area network, either public or private. Client computers 102 can access network 108 through an associated ISP 106, while client computers 104 can access network 108 through an associated proxy server 110. Thus, client computers 102 may not have anonymous communication while browsing.

Proxy server 110 provides client computers 104 with anonymous communication while browsing and accessing merchant servers 114 on network 108. Proxy server 110 can be implemented using a conventional proxy server, including those offered from Lucent Proxymate, Zero Knowledge and The Anonymizer. Client computers 102 and 104 can access financial institution server 112 in order to access their anonymous and non-anonymous financial account through network 108, wherein they can perform on line banking. Further, proxy server 110 can access financial institution server 112 in connection with anonymous financial transactions. Merchant servers 114 reside on network 108 and can be accessed by client computers 102 through ISPs 106, by client computers 104 through proxy servers 110, and by financial institution server 112. Thus, client computers 102 and 104 can make anonymous transactions at the merchant servers 112 using their anonymous financial account.

One of ordinary skill in the art will appreciate that systems consistent with the present invention can operate without the use of a proxy server 110. In particular, the software of server 110 can be stored at the client computers 104 to provide for anonymous network access. Alternatively, the user can access the Internet non-anonymously, but still make an anonymous purchasing transaction through a merchant's web site. In particular, the user can use the anonymous account and associated anonymous identity to make purchases without revealing the user's real name, mailing address, shipping address, account number (such as credit card number), or account expiration date.

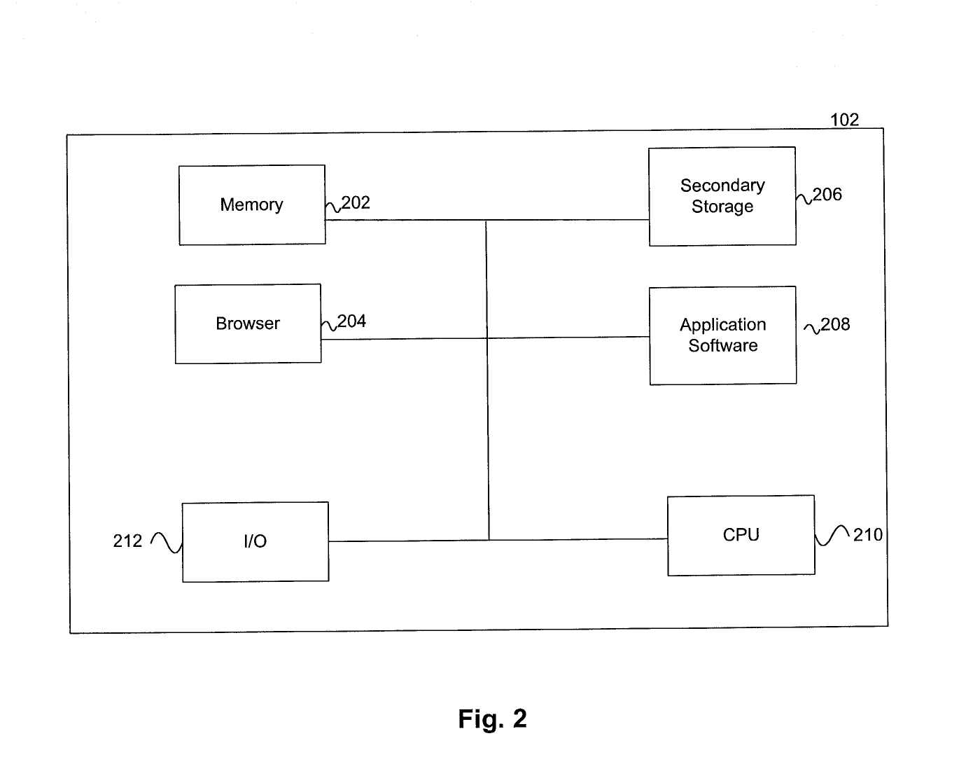

FIG. 2 depicts an exemplary block diagram of components contained in client computers 102 and 104. Client computers 102 and 104 may be any type of computing device, such as a personal computer or workstation, and may, for example, contain memory 202, browser software 204, secondary storage 206, software 208, central processing unit (CPU) 210 and input/output (I/O) devices 212. A user can access network 108 using browser software 204. Browser 204 may comprise a conventional browser application, including conventional browser applications available from Microsoft or Netscape. Software 208 contains programming instructions for implementing features of the present invention, such as assisting users with making anonymous purchases or accessing the financial account at financial institution server 112. In particular, software 208 can contain programming instructions for permitting access to the user's account at financial institution server 112 and/or access to proxy server 110. Software 208 may contain programming instructions for performing the functions of proxy server 110 for providing anonymous network access. Software 208 may also include a software component (such as an eWallet provided by either Microsoft, Brodia or CyberCash) to permit automatic loading of account information and other details for on-line transactions. The eWallet application can be pre-populated with the user's real and anonymous identity information. An eWallet is digital software that can hold a user's payment information, a digital certificate to identify the user, and shipping information to speed transactions.

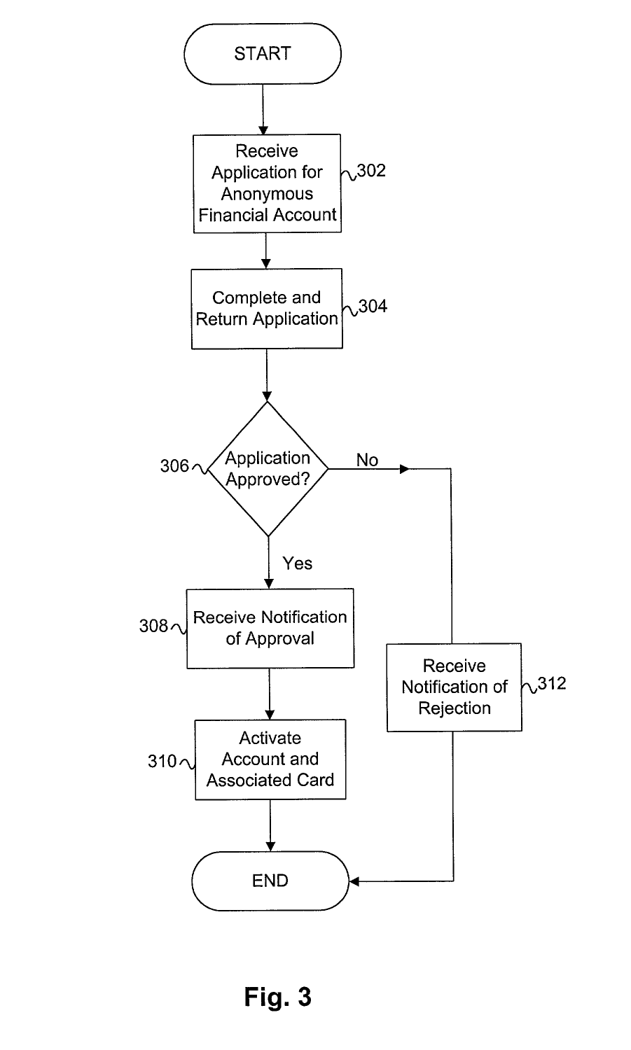

FIG. 3 depicts an exemplary flow chart of the steps performed by a user for establishing an anonymous financial account. As shown in FIG. 3, the user receives a solicitation from a financial institution offering the opportunity to apply for an anonymous financial account (Step 302). The solicitation can either contain a mailed application for the anonymous financial account or a universal resource locator (URL) where the user can access and complete an application on the Internet. Further, the user can apply for the anonymous financial account over the telephone or via email. The user then completes the application and submits it to the financial institution (Step 304). If the user is a current customer of the financial institution, no additional information is required, other than the request to apply for the anonymous card. If the user is not a current customer of the financial institution, the user may be required to submit additional identifying information in order for the financial institution to conduct a credit or background check. Consistent with the principles of the present invention, the user can receive or submit the application to the financial institution through a variety of means, including over the telephone, through regular mail, email, or the financial institution's web site. Alternatively, the user may apply directly to the financial institution without receiving a specific solicitation.

If the application is approved (Step 306), the user receives notification of the approval (Step 308) and can activate the account and associated anonymous card (Step 310). Alternatively, the card may be sent to the user pre-activated, and thus, require no user activation. The user may also receive software 208 for installation on the user's computer (e.g., client computers 102 or 104). A user may activate the account in a number of ways, including by making a telephone call to the financial institution, by mailing the financial institution, or by accessing financial institution server 112 on network 108. If the application is not approved, the user is notified of the rejection (Step 312). The user may, however, receive a counteroffer for a different financial product, such as a standard credit card or debit card, or a different anonymous card.

Consistent with the principles of the present invention, solicitations can be sent to a potentially new customer or to a current customer of the financial institution. If the current customer decides to apply for the anonymous financial account, that customer would preferably not need to submit a new application. The customer would merely have to respond to the offer in order to be considered for the new anonymous account.

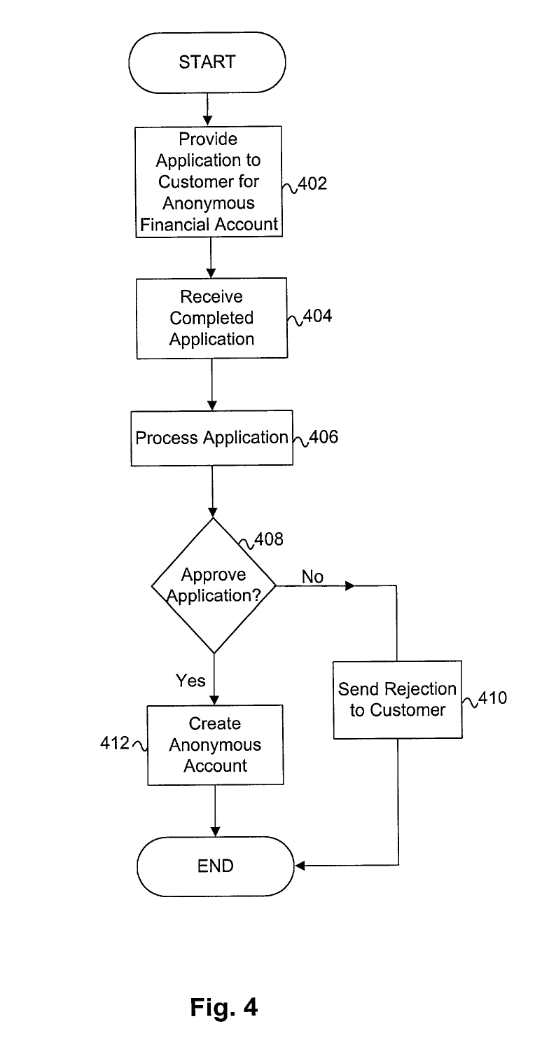

FIG. 4 depicts an exemplary flow chart of the steps taken by a financial institution for establishing an anonymous financial account and card. The issuing financial institution solicits customers using a marketing scheme to targeted customers who may be either existing or potential new customers (Step 402). The marketing scheme can provide the targeted new customers with a hard copy of the application, or provide a universal resource locator (URL) where the targeted customer can access the application on the Internet. In the alternative, the application can be sent through electronic form (such as email). The financial institution then receives and processes the completed application submitted from the selected customers (Steps 404 and 406).

The financial institution then determines whether or not to approve the application (Step 408). The institution may consider a number of factors in making this determination, including verifying the customer's identity and address, screening against fraudulent applications, and screening to ensure appropriate customer creditworthiness. If the application is rejected, a notice is sent to the customer advising them of the rejection (Step 410). The rejection may, however, contain a counteroffer for another financial product, such as a standard credit or debit card, or a different anonymous card. If the application is approved, then the financial institution creates an anonymous financial account for the user (Step 412).

In creating the anonymous financial account, the financial institution may issue an anonymous credit card bearing the user's anonymous identity and/or a standard credit card bearing the user's real identity. Thus, two plastic type cards can be issued. An anonymous financial account is also created and can be managed in conjunction with the non-anonymous or standard credit card account. The anonymous financial account can share the same credit line as the corresponding non-anonymous credit card account or can have a separate line of credit. The anonymous identity includes an anonymous name which is created and associated with the account for use in conducting anonymous transactions. The anonymous name can be used for the purposes of maintaining a user's anonymity. For example, the anonymous name can comprise a string of letters, numbers, or a combination of both. Further, the anonymous identity also includes an anonymous financial account number, address and expiration date, each of which can be created and associated with the anonymous account for use in conducting anonymous transactions. All anonymous account information is selected so that in the event standard checks are conducted to determine if a transaction is authentic, the transaction will not be suspended. In other words, the anonymous identifying information complies with any predefined data format requirements. For example, a valid state and zip code number can be associated with the anonymous information. The user is then notified and can be sent a card including the anonymous account identification.

In the alternative, an anonymous account can be created using a current customer's non-anonymous debit or pre-paid card account or stored value account. The financial institution can then create an anonymous identity and associate with the corresponding preexisting account. A line of credit is not necessarily associated with the account in which case the user would be required to maintain a balance in the account to conduct transactions. The account would thus operate either as a typical debit or stored value account.

In another alternative, the anonymous account can be created as an anonymous charge account. The financial institution can then create an anonymous identity and associate with the corresponding preexisting account. The user would have to pay the entire balance on the card on a monthly basis. The account would thus operate as a typical charge account.

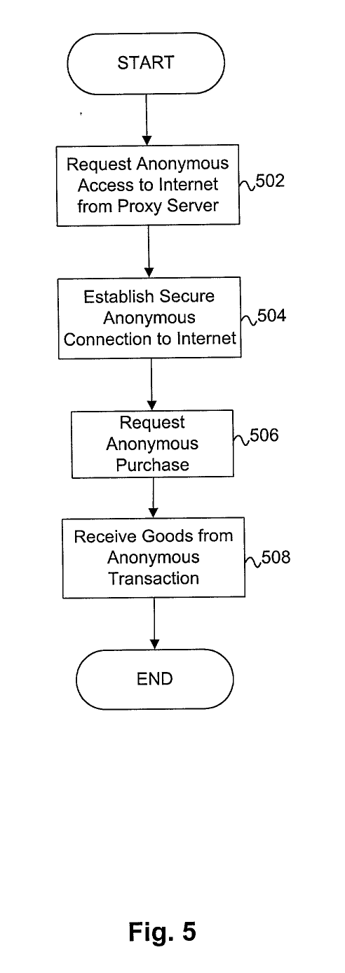

Once the anonymous financial account is created, the user can make anonymous transactions at merchant web sites operated by a merchant server 114. FIG. 5 is an exemplary flow chart of the steps performed by a user at client server 104 for accessing network 108 and conducting anonymous transactions. Client computer 104 accesses proxy server 110 requesting anonymous access to network 108 (Step 502). Proxy server 110 establishes a secure anonymous connection between client computer 104 and network 108 (Step 504). Once the connection between the client computer 104 and network 108 through proxy server 110 is established, the user can then browse anonymously and access sites on the network hosted by, for example, merchant servers 114.

The user can then select to purchase an item at the merchant server 114 anonymously (Step 506). Once the user has selected an item for anonymous purchase, the user is typically presented with a check-out form containing fields to be completed with information about the user. These fields may include name, address, and payment information. The user can access his eWallet, if available, in order to complete the check-out form fields. The eWallet may be accessible at client computer 104 or from a computer on network 108, e.g. financial institution 112, proxy server 110, or merchant server 114. In this latter case, the web site operated by server 114 may prompt the user to supply an authorization code in order to access the eWallet. In the alternative, the user can select to enter the fields manually. Further, the user can select to either use his anonymous identity, his real or non-anonymous identity, or components of both his anonymous and non-anonymous identity, in completing the check-out form. Finally, once the check-out form is submitted and the transaction authorized by the merchant and the financial institution, the user will receive the goods (Step 508).

In the embodiment of FIG. 5, the user does not need to access the network anonymously in order to make an anonymous purchase. For example, client computer 102 may access network 108 via ISP 106 and browse non-anonymously, without accessing proxy server 110. However, use of proxy server 110 adds additional anonymity in conducting transactions at merchant sites on the network. Further, it can be appreciated that client computer 102 can access proxy server 110 in order to browse anonymously.

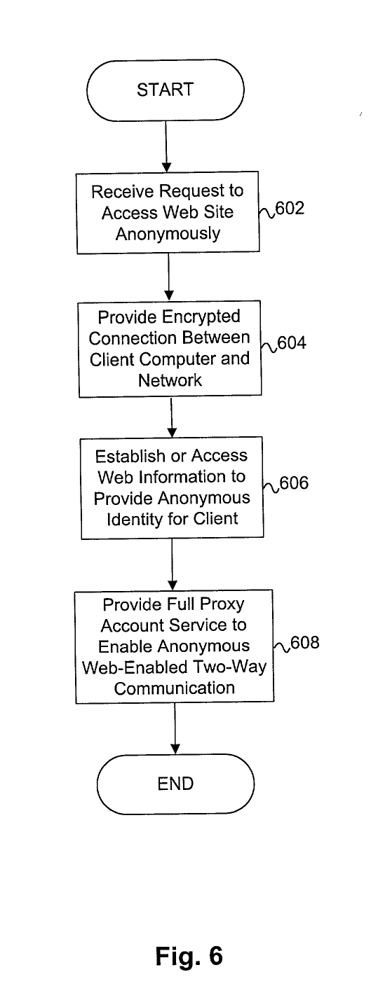

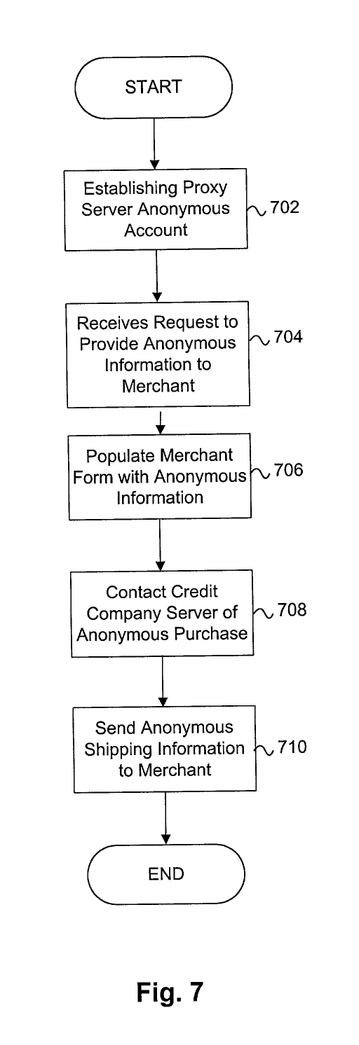

FIG. 6 depicts an exemplary flow chart of the steps performed by proxy server 110. Proxy server 110 receives a request from client computer 104 to establish a connection for anonymous access to network 108 (Step 602). Proxy server 110 establishes an encrypted connection between client computer 104 and network 108 (Step 604). Proxy server 110 can establish or access information to provide an anonymous identity for the client computer 104 (Step 606). Proxy server 110 can provide full proxy account service using the anonymous identity of client computer 104 to enable anonymous web-enabled two-way communication (Step 608). Thus, any information being transferred between client computer 104 and any other web site on network 108 is processed through proxy server 110, which maintains the anonymity of client computer 104.

It can be appreciated that proxy server 110 may establish a non-encrypted connection between client computers 104 and network 108. It can further be appreciated that an account can be created for the user at proxy server 110 such that the anonymous identity assigned to the user is the same anonymous identity assigned by the financial institution in connection with the anonymous financial account. Alternatively, financial institution 1 12 can manage proxy server 1 10. Thus, the anonymous identifying information provided by the financial institution can be used in establishing the user's account on proxy server 1 10.

As known in the art, proxy server 110 can further provide additional anonymity features for the user. For example, proxy server 110 can disguise the Internet Protocol (IP) address from which the user is connected, thereby preventing any party from knowing the actual IP address of the user. Proxy server 110 can serve as a re-emailing facility, by which the user can send and receive emails from a merchant or third party without revealing their identity. Proxy server 110 also can receive a cookie proxy that enables the user to have fully functional access to sites on the network that rely on downloaded cookies, without actually placing the cookies on the user's computer. Finally, proxy server 110 can provide a password manager that stores anonymous user names and passwords enabling the user to have anonymous accounts at web sites that require the user to register and use a password for access.

All of the above functions of proxy server 110 allow the user to adopt one or more anonymous identities while accessing the network. These functions also permit a user to maintain anonymity on network 108, from the perspective of the other sites on the network, that is unconnected to the user's real identity.

FIG. 7 is an exemplary flow chart of the steps performed by proxy server 110 in assisting a user in conducting an anonymous financial transaction in an embodiment of the present invention. As shown in FIG. 7, proxy server 110 establishes an anonymous connection for client computers 104 (Step 702). Client computers 104 can then anonymously browse on the Internet and access merchant web sites operated by merchant server 114. Once the merchant web sites are accessed, client computers 104 can select items to purchase. Client computers 104 can then request that proxy server 110 supply the merchant web site with the anonymous information (Step 704). Proxy server 110 then supplies the merchant web site with the anonymous identifying information, which may include the anonymous financial account information (e.g. by accessing the user's eWallet residing at proxy server 110) (Step 706). Proxy server 110 can then notify the financial institution server 112 of the transaction, including what goods the user purchased (Step 708). This can be accomplished as the user's anonymous identity used by proxy server 110 can be the same anonymous identity assigned by the financial institution. Thus, proxy server 110 can contain programming instructions such that, when the user makes a purchase, (i.e., the user clicks on the “buy” push-button at the merchant's web site) proxy server 110 can notify the financial institution. Proxy server 110 can then send to the merchant the user's shipping information, which can be stored at proxy server 110 (Step 710). Finally, as described above, it can be appreciated that client computers 102 can also access proxy server through network 108.

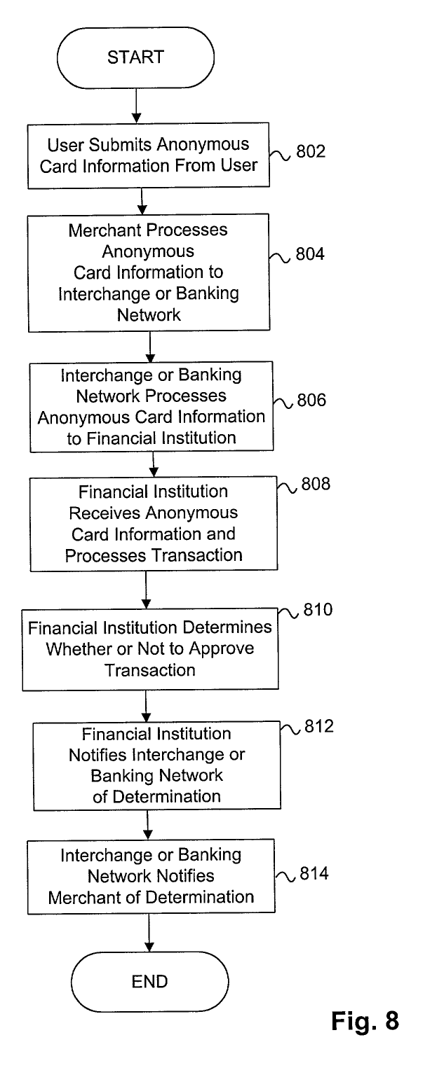

FIG. 8 is an exemplary flow chart of the steps performed for processing an anonymous transaction. Once client computers 102 non-anonymously access merchant server 114 on network 108, or client computers 104 anonymously access merchant server 114 on network 108, the user selects a service or product to purchase and completes a check-out form by providing the anonymous identity information to merchant server 114 (Step 802). The anonymous identity information can be provided by the user, manually or through software residing at the client computer (e.g. an eWallet), or by proxy server 110, if available. As described above, the anonymous identity information can include one or more of the user's anonymous name, address and card number. The merchant receives and processes this information (Step 804). In particular, the merchant may determine the authenticity of the transaction by examining the information provided by the user. For example, the merchant may look at whether all fields in the check out form are completed. The merchant may also conduct a standard fraud screening procedure known in the art, such as eFalcon or RiskWise.

It can be appreciated that in addition to network-based communication, the user may contact the merchant via telephone or mail and engage in any anonymous financial transaction not requiring the physical presence of the card (i.e. a “card not present” transaction).

The merchant then submits a request to an interchange or banking network, such as the Visa/MC network, the American Express network or the Discover network, requesting authorization of the transaction. The transaction request is processed and submitted to the financial institution that maintains the account (Step 806). Once the financial institution receives the request, it examines the anonymous identity information contained in the transaction (Step 808). The financial institution then determines whether the anonymous account number is located in its records, and examines the account to determine whether or not the transaction should be approved. For example, depending on the type of financial account (i.e. credit, charge, debit, or stored value), the financial institution can look at the balance on the account or the status of the account to see if the account is suspended. After performing the standard transaction procedures, the financial institution then determines whether or not to approve the transaction (Step 810). If the transaction is approved, the anonymous account is updated with the transaction. The determination is then forwarded to the interchange or banking network (Step 812) to thereby notify the merchant whether the transaction was approved or denied (Step 814).

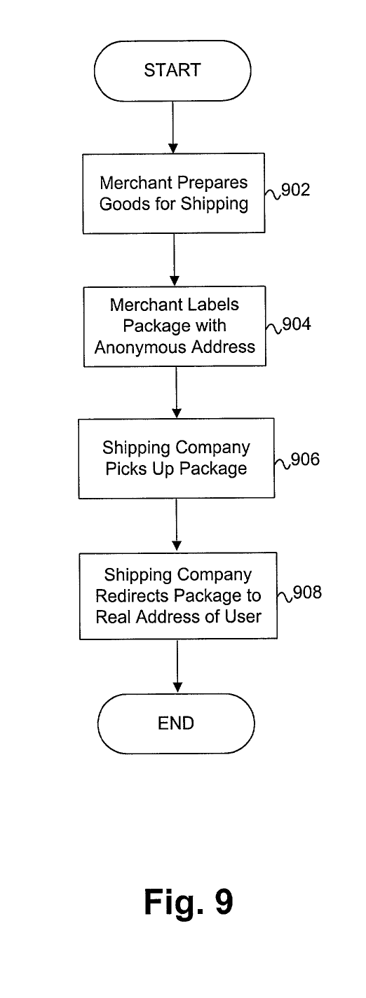

FIG. 9 is an exemplary flow chart of the steps for shipping goods purchased anonymously. As shown in FIG. 9, assuming the transaction has been approved, the merchant prepares to send the purchased item to the user using the shipping address provided in the initial check-out form (Step 902). In order to continue the anonymity of the user, an anonymous shipping address can be provided to the merchant. As such, the merchant packages the item and labels the item for shipping with the user's anonymous address (Step 904). The merchant then contacts a shipping company to pick up the package (Step 906). In advance of the transaction, the shipping company is provided with a table or database that correlates the user's real name and shipping information with the user's anonymous name and shipping information. As such, when the shipping company picks up the package, they can direct the package to the user's real address and denote the real address on the package, for example, by relabeling the package (Step 908).

The shipper might know to relabel the package by examining the label the merchant placed on the package. A code can be incorporated in the label such that when the shipping company picks up the package, the shipper can see that anonymous shipping information is used and that the package would need to be redirected. For example, the code can be located in the anonymous name, e.g. “NameSafe John Smith”. When the shipper picks up the package and sees the code “NameSafe”, he would search his database for “John Smith”, a unique identifier associated with the user's non-anonymous name, and access the user's non-anonymous shipping information. Alternatively, the code can be located in the anonymous address, e.g. “Redirect 123 Main Street”. When the shipper sees the word “redirect”, he would search his database for “123 Main Street”, a unique address associated with the user's non-anonymous address, and access the user's non-anonymous shipping information. It can be appreciated that the code can be incorporated anywhere on the label. The shipper, noticing the code incorporated in the label informing his that anonymous shipping information is being used, he would need to access the user's non-anonymous shipping information from the database and relabel the package.

Consistent with the principles of the invention, anonymous shipping can occur in other ways. For example, the anonymous address can indicate a hold location, for example, Mailboxes etc., wherein the user can present their anonymous identification card to pick up the package. Alternatively, the package can be sent to a post office box wherein the user can have a key to pick up the package. Further, consistent with the principles of the invention, if the goods are digital (e.g. software or electronic documents), they require no physical shipment, and the user can receive the goods through network 108 and proxy server 110, wherein anonymity can be maintained. Alternatively, the package can be sent to a central location (which may be operated by the financial institution or a third party) where it is then relabeled with the user's real name and address and shipped to the user.

If the user wishes to return the product to the merchant, the user can either contact the merchant using their real identity, or the user can select to contact the merchant using their anonymous identity. For example, the user can contact the merchant through email using proxy server 110. The user can also mail the item to the merchant using their anonymous identity. The user's anonymous account can be credited with the purchase amount using the steps set forth above.

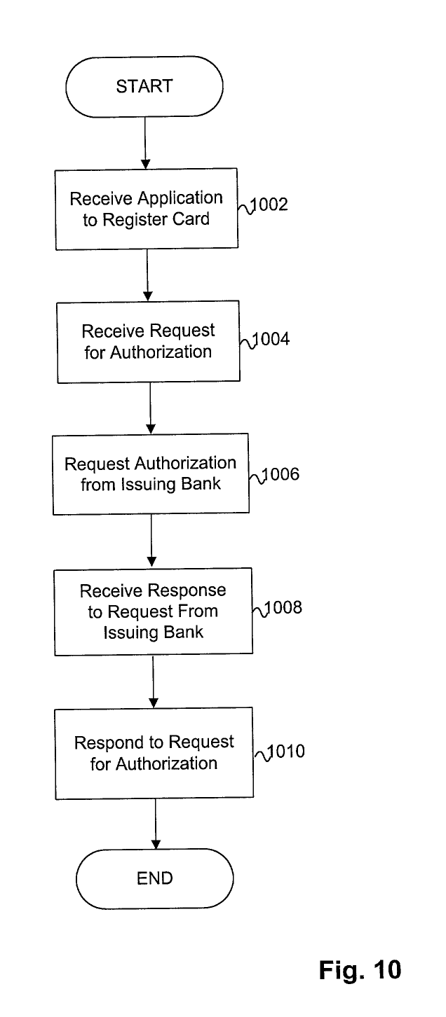

Consistent with the principles of the invention, a financial institution or a bank can issue an anonymous card to a user who maintains a financial account with a different financial institution or bank. For example, a user, who maintains a credit card with Citibank, can apply to Capital One for a anonymous card associated with the Citibank account. As shown in FIG. 10, Capital One would receive a request to register the Citibank card (Step 1002). Capital One may then decide to issue an anonymous card, having an anonymous name, address, account number and/or expiration date. If the user decides to make a purchase at a merchant site, the merchant would request authorization via the interchange or banking network associated with the anonymous card. Following normal procedures, the request is then forwarded to the issuer of the anonymous card, i.e. Capital One (Step 1004). Capital One would then identify the real identity information associated with the anonymous identity information of the anonymous card and forward the request on to the issuing bank of the standard card, i.e. Citibank requesting authorization (Step 1006). The issuing bank would then decide whether or not to authorize the transaction and notify the anonymous account provider, i.e. Capital One (Step 1008). Capital One would then forward the decision on to the merchant using the appropriate interchange or banking network (Step 1010). In this way, the user does not maintain a regular financial account with Capital One, but can still conduct anonymous transactions on network 108.

Modifications and adaptations of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method of providing an anonymous financial account, comprising:
receiving financial account application information from an applicant for the anonymous financial account;
processing the financial account application information for the applicant to determine if the anonymous financial account should be opened for the applicant;
determining that the financial account application has been accepted; and
establishing the anonymous financial account for the applicant.

2. The method according to claim 1, wherein the anonymous financial account contains at least one of an anonymous name, address, account number and expiration date.

3. The method according to claim 1, further comprising associating the anonymous financial account with a non-anonymous financial account.

4. The method according to claim 3, wherein a financial card associated with the non-anonymous financial account is issued to the accepted applicant.

5. The method according to claim 3, wherein the anonymous financial account and the non-anonymous financial accounts are credit accounts and share a credit line.

6. The method according to claim 1, wherein the anonymous name can only be associated to the applicant by the applicant and an anonymous financial account provider.

7. The method according to claim 1, wherein the anonymous financial account includes an anonymous billing address.

8. The method according to claim 7, wherein the anonymous billing address can only be associated to the applicant by the applicant and an anonymous financial account provider.

9. The method according to claim 1, wherein information associated with the anonymous financial account is provided to the accepted applicant on an information storage medium.

10. The method according to claim 1, further comprising providing an electronic wallet application with or without anonymous financial account information stored therein.

11. The method according to claim 1, wherein a card associated with the anonymous financial account is issued by an anonymous financial account provider to the accepted applicant.

12. The method according to claim 1, wherein the application information from the applicant includes information sufficient to verify at least one of the applicant's identity, credit worthiness, billing address, and shipping address.

13. The method according to claim 1, wherein the application information from the applicant includes an accepted legal contract specifying that the applicant is responsible for all purchases made anonymously or otherwise.

14. The method according to claim 1, wherein the processing includes one or more of verifying, based on the financial account application information, at least one of the applicant's identity, billing address and shipping address, screening against fraudulent applications, and screening for the applicant's creditworthiness.

15. The method according to claim 1, wherein the financial account application information is received through at least one of an Internet web page, through an email message, through regular mail, and by telephone.

16. A method of providing for anonymous financial transactions, comprising:
receiving a request to process an anonymous financial transaction containing anonymous information;
accessing an anonymous financial account using the anonymous information for processing;
determining that the anonymous transaction should be approved; and
responding to the request that the anonymous transaction is approved.

17. The method of claim 16, wherein the anonymous information contains at least one of an anonymous name, account number, expiration date, shipping address and billing address.

18. The method of claim 16, wherein processing includes updating the anonymous account with the transaction.

19. A method for making an anonymous financial transaction comprising:
applying for an anonymous financial account;
opening an anonymous financial account with an anonymous financial account provider;
making an anonymous purchase on the anonymous financial account; and
receiving the goods of the anonymous purchase.

20. The method of claim 19, wherein the anonymous financial account contains at least one of an anonymous name, address, account number, and expiration date.

21. The method of claim 20, wherein the anonymous financial account is associated with a non-anonymous financial account.

22. The method of claim 19, wherein the anonymous purchase is conducted at a web site.

23. The method of claim 19, wherein the anonymous purchase is conducted using a telephone.

24. The method of claim 19, wherein the anonymous purchase is conducted using regular mail.

25. A method for shipping goods purchased from a merchant using an anonymous financial account so that the goods are received by a consumer associated with the anonymous financial account, the consumer having an anonymous shipping address, said method comprising:
labeling the goods with the anonymous shipping address; and
delivering the goods to the consumer based on the anonymous shipping address.

26. The method according to claim 25, wherein the purchased goods are addressed by the merchant to an actual name of the consumer at the anonymous shipping address.

27. The method according to claim 25, wherein the anonymous shipping address is detected during shipping by a shipping company and wherein the shipping company identifies an actual address of the consumer and re-directs the goods to the actual address of the consumer.

28. The method according to claim 25, wherein the anonymous shipping address is a hold location wherein the consumer can collect the goods by providing identifying information.

29. The method according to claim 25, wherein the anonymous shipping address is a post office box.

30. The method according to claim 25, wherein the anonymous shipping address is a central location wherein the package is relabeled with the consumer's actual address and reshipped to the consumer.

31. A method for conducting an anonymous financial transaction comprising:
accessing a site on a network anonymously;
purchasing goods from the site using an anonymous financial account; and
receiving the goods from the purchase.

32. The method of claim 31, wherein accessing the site on the network includes using a proxy server to access the network anonymously.

33. The method of claim 31, wherein the anonymous financial account is associated with at least one of an anonymous name, billing address, shipping address, account number and expiration number.

34. The method of claim 31, wherein receiving the goods from the purchase further includes:
providing an anonymous shipping address to the site; and
picking up the goods shipped from a hold location.

35. The method of claim 31, wherein receiving the goods from the purchase further includes:
providing an anonymous shipping address to the site wherein the anonymous shipping address is a post office box.

36. The method of claim 31, wherein receiving the goods from the purchase further includes:
providing an anonymous shipping address; and
providing for a shipping company to deliver the goods wherein the shipping company detects the anonymous shipping address and redirect the goods to an actual address of a consumer based on the anonymous shipping address.

37. A method for providing for anonymous financial transactions comprising:
receiving a request to register a financial account from an issuing financial provider as an anonymous financial account;
establishing an anonymous financial account associated with the financial account in response to the request;
receiving a request to purchase goods from a merchant using the anonymous financial account;
processing the request from the merchant; and
responding to the merchant's request including a response.

38. The method of claim 37, wherein processing the request further includes:
requesting from the issuing financial provider authorization to process the request to purchase goods; and
receiving a response to the request to purchase goods from the issuing financial provider.

39. A computer-readable medium containing instructions for providing an anonymous financial account, comprising:
receiving financial account application information from an applicant for the anonymous financial account;
processing the financial account application information for the applicant to determine if the anonymous financial account should be opened for the applicant;
determining that the financial account application has been accepted; and
establishing the anonymous financial account for the applicant.

40. The computer-readable medium according to claim 39, wherein the anonymous financial account contains at least one of an anonymous name, address, account number and expiration date.

41. The computer-readable medium according to claim 39, further comprising associating the anonymous financial account with a non-anonymous financial account.

42. The computer-readable medium according to claim 41, wherein a financial card associated with the non-anonymous financial account is issued to the accepted applicant.

43. The computer-readable medium according to claim 41, wherein the anonymous financial account and the non-anonymous financial accounts are credit accounts and share a credit line.

44. The computer-readable medium according to claim 39, wherein the anonymous name can only be associated to the applicant by the applicant and an anonymous financial account provider.

45. The computer-readable medium according to claim 39, wherein the anonymous financial account includes an anonymous billing address.

46. The computer-readable medium according to claim 45, wherein the anonymous billing address can only be associated to the applicant by the applicant and an anonymous financial account provider.

47. The computer-readable medium according to claim 39, wherein information associated with the
anonymous financial account is provided to the accepted applicant on an information storage medium.

48. The computer-readable medium according to claim 39, further comprising providing an electronic wallet application with or without anonymous financial account information stored therein.

49. The computer-readable medium according to claim 39, wherein a card associated with the
anonymous financial account is issued by an anonymous financial account provider to the accepted applicant.

50. The computer-readable medium according to claim 39, wherein the application information from the applicant includes information sufficient to verify at least one of the applicant's identity, credit worthiness, billing address, and shipping address.

51. The computer-readable medium according to claim 39, wherein the application information from the applicant includes an accepted legal contract specifying that the applicant is responsible for all purchases made anonymously or otherwise.

52. The computer-readable medium according to claim 39, wherein the processing includes one or more of verifying, based on the financial account application information, at least one of the applicant's identity, billing address and shipping address, screening against fraudulent applications, and screening for the applicant's creditworthiness.

53. The computer-readable medium according to claim 39, wherein the financial account application information is received through at least one of an Internet web page, through an email message, through regular mail, and by telephone.

54. A computer-readable medium containing instructions for providing for anonymous financial transactions, comprising:
receiving a request to process an anonymous financial transaction containing anonymous information;
accessing an anonymous financial account using the anonymous information for processing;
determining that the anonymous transaction should be approved; and
responding to the request that the anonymous transaction is approved.

55. The computer-readable medium of claim 54, wherein the anonymous information contains at least one of an anonymous name, account number, expiration date, shipping address and billing address.

56. The computer-readable medium of claim 54, wherein processing includes updating the anonymous account with the transaction.

57. A computer-readable medium containing instructions for making an anonymous financial transaction comprising:
applying for an anonymous financial account;
opening an anonymous financial account with an anonymous financial account provider;
making an anonymous purchase on the anonymous financial account; and
receiving the goods of the anonymous purchase.

58. The computer-readable medium of claim 57, wherein the anonymous financial account contains at least one of an anonymous name, address, account number, and expiration date.

59. The computer-readable medium of claim 58, wherein the anonymous financial account is associated with a non-anonymous financial account.

60. The computer-readable medium of claim 58, wherein the anonymous purchase is conducted at a web site.

61. The computer-readable medium of claim 58, wherein the anonymous purchase is conducted using a telephone.

62. The computer-readable medium of claim 58, wherein the anonymous purchase is conducted using regular mail.

63. A computer-readable medium containing instructions for shipping goods purchased from a merchant using an anonymous financial account so that the goods are received by a consumer associated with the anonymous financial account, the consumer having an anonymous shipping address, comprising:
labeling the goods with the anonymous shipping address; and
delivering the goods to the consumer based on the anonymous shipping address.

64. The computer-readable medium according to claim 63, wherein the purchased goods are addressed by the merchant to an actual name of the consumer at the anonymous shipping address.

65. The computer-readable medium according to claim 63, wherein the anonymous shipping address is detected during shipping by a shipping company and wherein the shipping company identifies an actual address of the consumer and re-directs the goods to the actual address of the consumer.

66. The computer-readable medium according to claim 63, wherein the anonymous shipping address is a hold location wherein the consumer can collect the goods by providing identifying information.

67. The computer-readable medium according to claim 63, wherein the anonymous shipping address is a post office box.

68. The computer-readable medium according to claim 63, wherein the anonymous shipping address is a central location wherein the package is relabeled with the consumer's actual address and reshipped to the consumer.

69. A computer-readable medium containing instructions for conducting an anonymous financial transaction comprising:
accessing a site on a network anonymously;
purchasing goods from the site using an anonymous financial account; and
receiving the goods from the purchase.

70. The computer-readable medium of claim 69, wherein accessing the site on the network includes using a proxy server to access the network anonymously.

71. The computer-readable medium of claim 69, wherein the anonymous financial account is associated with at least one of an anonymous name, billing address, shipping address, account number and expiration number.

72. The computer-readable medium of claim 69, wherein receiving the goods from the purchase further includes:
providing an anonymous shipping address to the site; and
picking up the goods shipped from a hold location.

73. The computer-readable medium of claim 69, wherein receiving the goods from the purchase further includes:
providing an anonymous shipping address to the site wherein the anonymous shipping address is a post office box.

74. The computer-readable medium of claim 69, wherein receiving the goods from the purchase further includes:
providing an anonymous shipping address; and
providing for a shipping company to deliver the goods wherein the shipping company detects the anonymous shipping address and redirect the goods to an actual address of a consumer based on the anonymous shipping address.

75. A computer-readable medium containing instructions for providing for anonymous financial transactions comprising:
receiving a request to register a financial account from an issuing financial provider as an anonymous financial account;
establishing an anonymous financial account associated with the financial account in response to the request;
receiving a request to purchase goods from a merchant using the anonymous financial account;
processing the request from the merchant; and
responding to the merchant's request including a response.

76. The computer-readable medium of claim 75, wherein processing the request further includes:
requesting from the issuing financial provider authorization to process the request to purchase goods; and
receiving a response to the request to purchase goods from the issuing financial provider.

77. A system for providing an anonymous financial account, comprising:
means for receiving financial account application information from an applicant for the anonymous financial account;
means for processing the financial account application information for the applicant to determine if the anonymous financial account should be opened for the applicant;
means for determining that the financial account application has been accepted; and
means for establishing the anonymous financial account for the applicant.

78. The system according to claim 77, wherein the anonymous financial account contains at least one of an anonymous name, address, account number and expiration date.

79. The system according to claim 77, further comprising associating the anonymous financial account with a non-anonymous financial account.

80. The system according to claim 79, wherein a financial card associated with the non-anonymous financial account is issued to the accepted applicant.

81. The system according to claim 79, wherein the anonymous financial account and the non-anonymous financial accounts are credit accounts and share a credit line.

82. The system according to claim 77, wherein the anonymous name can only be associated to the applicant by the applicant and an anonymous financial account provider.

83. The system according to claim 77, wherein the anonymous financial account includes an anonymous billing address.

84. The system according to claim 83, wherein the anonymous billing address can only be associated to the applicant by the applicant and an anonymous financial account provider.

85. The system according to claim 77, wherein information associated with the anonymous financial account is provided to the accepted applicant on an information storage medium.

86. The system according to claim 77, further comprising providing an electronic wallet application with or without anonymous financial account information stored therein.

87. The system according to claim 77, wherein a card associated with the anonymous financial account is issued by an anonymous financial account provider to the accepted applicant.

88. The system according to claim 77, wherein the application information from the applicant includes information sufficient to verify at least one of the applicant's identity, credit worthiness, billing address, and shipping address.

89. The system according to claim 77, wherein the application information from the applicant includes an accepted legal contract specifying that the applicant is responsible for all purchases made anonymously or otherwise.

90. The system according to claim 77, wherein the processing includes one or more of verifying, based on the financial account application information, at least one of the applicant's identity, billing address and shipping address, screening against fraudulent applications, and screening for the applicant's creditworthiness.

91. The system according to claim 77, wherein the financial account application information is received through at least one of an Internet web page, through an email message, through regular mail, and by telephone.

92. A system for providing for anonymous financial transactions, comprising:
means for receiving a request to process an anonymous financial transaction containing anonymous information;
means for accessing an anonymous financial account using the anonymous information for processing;
means for determining that the anonymous transaction should be approved; and
means for responding to the request that the anonymous transaction is approved.

93. The system of claim 92, wherein the anonymous information contains at least one of an anonymous name, account number, expiration date, shipping address and billing address.

94. The system of claim 92, wherein processing includes updating the anonymous account with the transaction.

95. A system for making an anonymous financial transaction comprising:
means for applying for an anonymous financial account;
means for opening an anonymous financial account with an anonymous financial account provider;
means for making an anonymous purchase on the anonymous financial account; and
means for receiving the goods of the anonymous purchase.

96. The system of claim 95, wherein the anonymous financial account contains at least one of an anonymous name, address, account number, and expiration date.

97. The system of claim 96, wherein the anonymous financial account is associated with a non-anonymous financial account.

98. The system of claim 96, wherein the anonymous purchase is conducted at a web site.

99. The system of claim 96, wherein the anonymous purchase is conducted using a telephone.

100. The system of claim 96, wherein the anonymous purchase is conducted using regular mail.

101. A system for shipping goods purchased from a merchant using an anonymous financial account so that the goods are received by a consumer associated with the anonymous financial account, the consumer having an anonymous shipping address, comprising:
means for labeling the goods with the anonymous shipping address; and
means for delivering the goods to the consumer based on the anonymous shipping address.

102. The system according to claim 101, wherein the purchased goods are addressed by the merchant to an actual name of the consumer at the anonymous shipping address.

103. The system according to claim 101, wherein the anonymous shipping address is detected during shipping by a shipping company and wherein the shipping company identifies an actual address of the consumer and re-directs the goods to the actual address of the consumer.

104. The system according to claim 101, wherein the anonymous shipping address is a hold location wherein the consumer can collect the goods by providing identifying information.

105. The system according to claim 101, wherein the anonymous shipping address is a post office box.

106. The system according to claim 101, wherein the anonymous shipping address is a central location wherein the package is relabeled with the consumer's actual address and reshipped to the consumer.

107. A system for conducting an anonymous financial transaction comprising:
means for accessing a site on a network anonymously;
means for purchasing goods from the site using an anonymous financial account; and
means for receiving the goods from the purchase.

108. The system of claim 107, wherein accessing the site on the network includes using a proxy server to access the network anonymously.

109. The system of claim 107, wherein the anonymous financial account is associated with at least one of an anonymous name, billing address, shipping address, account number and expiration number.

110. The system of claim 107, wherein receiving the goods from the purchase further includes:
means for providing an anonymous shipping address to the site; and
means for picking up the goods shipped from a hold location.

111. The system of claim 107, wherein receiving the goods from the purchase further includes:
means for providing an anonymous shipping address to the site wherein the anonymous shipping address is a post office box.

112. The system of claim 107, wherein receiving the goods from the purchase further includes:
means for providing an anonymous shipping address; and
means for providing for a shipping company to deliver the goods wherein the shipping company detects the anonymous shipping address and redirect the goods to an actual address of a consumer based on the anonymous shipping address.

113. A system for providing for anonymous financial transactions comprising:
means for receiving a request to register a financial account from an issuing financial provider as an anonymous financial account;
means for establishing an anonymous financial account associated with the financial account in response to the request;
means for receiving a request to purchase goods from a merchant using the anonymous financial account;
means for processing the request from the merchant; and
means for responding to the merchant's request including a response.

114. The system of claim 113, wherein processing the request further includes:
means for requesting from the issuing financial provider authorization to process the request to purchase goods; and
means for receiving a response to the request to purchase goods from the issuing financial provider.
